(19) United States
(12) Patent Application Publication
(10) Pub. No.: US 2025/0170016 A1
(43) Pub. Date: May 29, 2025

(54) Angle-adjustable sauna cabin

(71) Applicant: SHU-LIEN CHEN, Taichung City (TW)

(72) Inventor: SHU-LIEN CHEN, Taichung City (TW)

(21) Appl. No.: 18/916,751

(22) Filed: Oct. 16, 2024

(30) Foreign Application Priority Data
Nov. 28, 2023 (TW) 112146186

(51) Int. Cl. A61H 33/06

(52) U.S. Cl. CPC A61H 33/067

(57) ABSTRACT

An angle-adjustable sauna cabin includes a cabin body supported by a base; a hatch cover connected with the cabin body that allows opening and closing; a controller arranged at a position that allows a user in the cabin body to be touched and operated; and an adjusting mechanism used to adjust an inclination angle of the cabin body, wherein the controller is electrically connected with the adjusting mechanism, and the controller provides the inclination angle of the cabin body for the user to pre-select, so that a parameter of controlling the adjusting mechanism is obtained, and then the adjusting mechanism is controlled to regulate the cabin body to the inclination angle preselected by the user.

### BACKGROUND OF THE PRESENT INVENTION

### FIELD OF INVENTION

The present invention relates to a personal sauna machine, and more specifically, to an angle-adjustable sauna cabin.

### DESCRIPTION OF RELATED ARTS

Sauna (Finnish: sauna; translated as sauna in mainland China and Hong Kong, also known as Finland bath) refers to the process of using steam or dry heat to treat the human body in a closed space, causing people to sweat profusely.

The public sauna is built in public sports centers and sports venues, providing room-type cabins that can be shared by multiple people, providing steam or dry heat in them, and using temperature and humidity monitoring and control to maintain the ideal therapeutic effect and protect the safety of use.

The personal seated sauna is mainly made of wood or canvas to construct the cabin, and a seat is provided in the cabin for one user to sit in, with the head sticking out of the outside of the cabin for the sauna treatment procedure.

The personal horizontal sauna is mainly made of canvas material to construct a tunnel-like cabin, which is used by a user to lie and his/her head sticking out of the cabin for the sauna treatment procedure.

### SUMMARY OF THE PRESENT INVENTION

The problem to be solved by the present invention:

The personal sauna cabin is for sitting or lying down only, and the user cannot change the position according to their needs of the user.

Technical means for solving the problem of the present invention:

An angle-adjustable sauna cabin includes a cabin body supported by a base; a hatch cover connected with the cabin body that allows opening and closing; a controller arranged at a position that allows a user in the cabin body to be touched and operated; and an adjusting mechanism used to adjust an inclination angle of the cabin body, wherein the controller is electrically connected with the adjusting mechanism, and the controller provides the inclination angle of the cabin body for the user to pre-select, so that a parameter of controlling the adjusting mechanism is obtained, and then the adjusting mechanism is controlled to regulate the cabin body to the inclination angle preselected by the user.

The benefits of the present invention:

The inclination angle of the sauna cabin can be pre-selected by the user, so that the user can perform the sauna process in a suitable and comfortable position.

### BRIEF DESCRIPTION OF THE DRAWINGS

FIG. 1 is a perspective view of the sauna cabin of the present invention.

FIG. 2 is a side view of the sauna cabin of the present invention.

FIG. 3 is a partial sectional view of the first use angle of the sauna cabin according to the first embodiment of the present invention.

FIG. 4 is a partial sectional view of the second use angle of the sauna cabin according to the first embodiment of the present invention.

FIG. 5 is a partial sectional view of the first use angle of the sauna cabin according to the second embodiment of the present invention.

FIG. 6 is a partial sectional view of the second use angle of the sauna cabin according to the second embodiment of the present invention.

### DETAILED DESCRIPTION OF THE PREFERRED EMBODIMENT

In order to facilitate the explanation of the central concept expressed in the above-mentioned summary of the present invention, specific embodiments are hereby expressed. Various objects in the embodiments are drawn according to the proportions, sizes, deformations or displacements suitable for illustration, rather than according to the proportions of actual components. In the following description, components with the same and symmetrical configurations are represented by the same number.

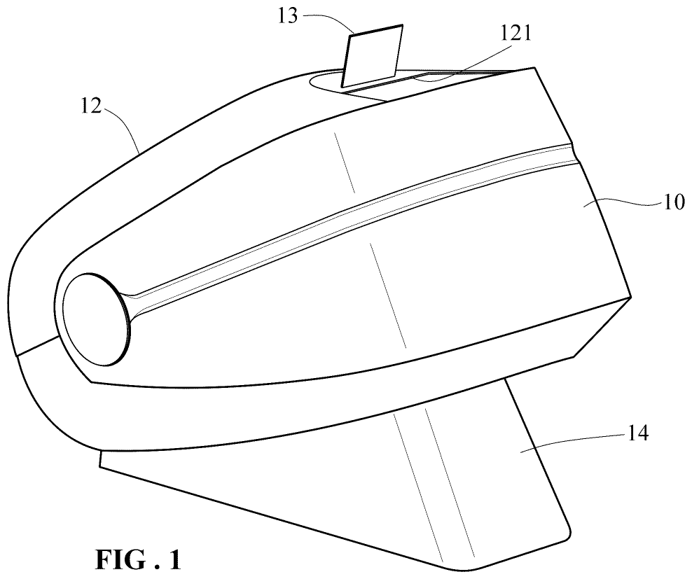

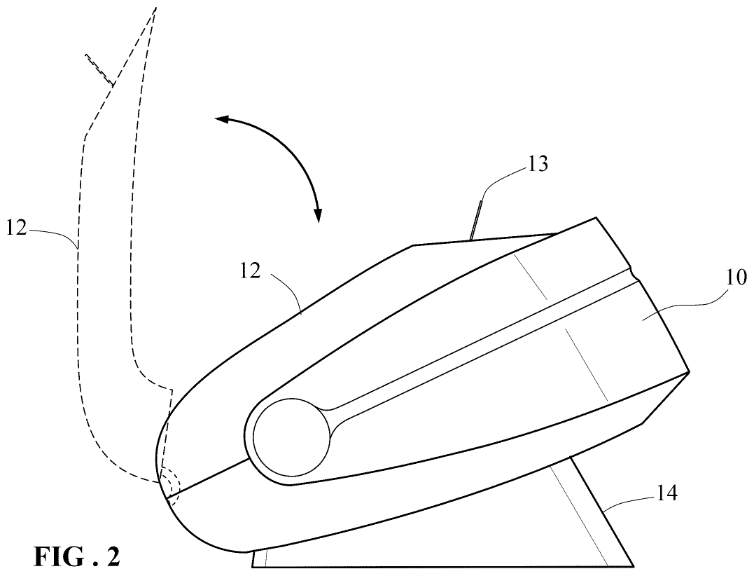

As shown in FIGS. 1 to 3, the cabin body 10 of the sauna of the present invention includes a supporting structure 11 provided therein for a single person semi-recumbent position. The cabin body 10 also has a steam or dry heat device (not shown in the figure) arranged therein, and temperature and humidity are measured and controlled to maintain the ideal physiotherapy effect and protect the safety of the user.

The cabin body 10 is connected with a hatch cover 12, and the hatch cover 12 is allowed to be opened and closed relative to the cabin body 10, thereby closing or opening the cabin body 10. The hatch cover 12 has an opening 121, and the opening 121 is located corresponds to a head neck position 111 of the supporting structure 11. When the user is in the cabin body 10 and the whole body is fully supported by the supporting structure 11, the hatch cover 12 is allowed to be closed on the cabin body 10, and the user's head and neck are exposed outside through the opening 121 of the hatch cover 12.

A controller 13 is arranged on the hatch cover 12, and the user who is located in the cabin body 10 is allowed to touch and operate the controller 13. The controller 13 is electrically connected with a steam or dry heat device (not shown in the figure) and a temperature control device (not shown in the figure) provided in the cabin body 10. The controller 13 provides the controllable items of the above-mentioned device for the user to pre-select, and the controllable items refer to the items that are allowed to be selected and adjusted by the user, such as the user is allowed to select steam or dry heat, and select a temperature value within a safe range. The controllable items display the panel of the controller 13, wherein the panel is allowed to be an electronic touch panel, or an operation panel including a display and physical keys or buttons.

The cabin body 10 is supported on a base 14 placed on the ground. An adjusting mechanism 20 is connected between the cabin body 10 and the base 14, and the adjustment mechanism 20 is used to adjust an inclination angle of the cabin body 10, wherein the inclination angle is defined by the relative angle θ between an axis line XL and a baseline BL. The axis line XL refers to a virtual line passing through the front and back directions of the cabin body 10 in this invention. The baseline BL refers to any horizontal line passing through the front and back directions of the base 14 in this invention.

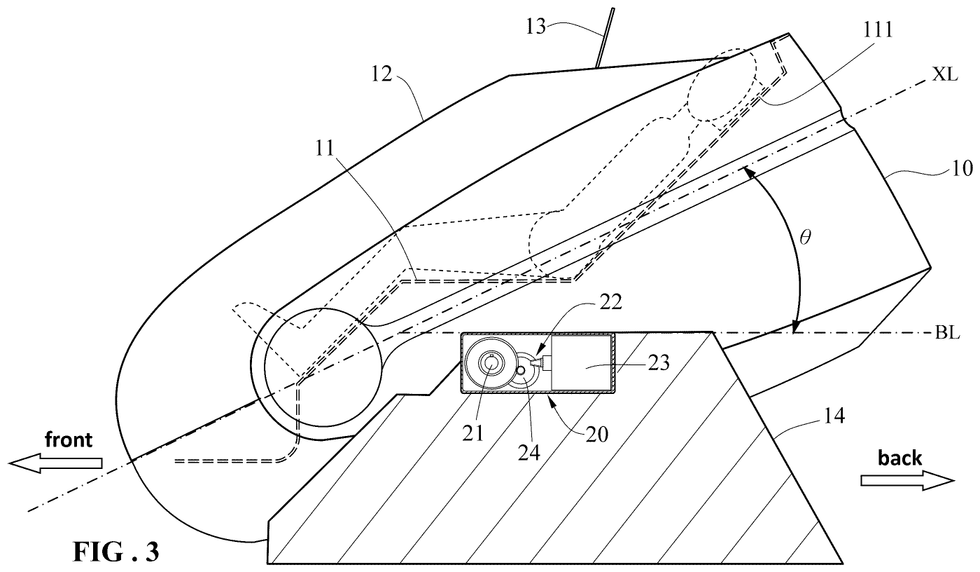

As shown in FIGS. 3 to 6, the adjusting mechanism 20 includes a rotating shaft 21 and a driving device 22 that drives the rotating shaft 21 to rotate clockwise or counterclockwise at a predetermined angle around an axis thereof. The rotating shaft 21 is provided on the cabin body 10, and the driving device 22 is provided on the base 14. The rotation angle of the rotating shaft 21 controls the inclination angle of the cabin body 10.

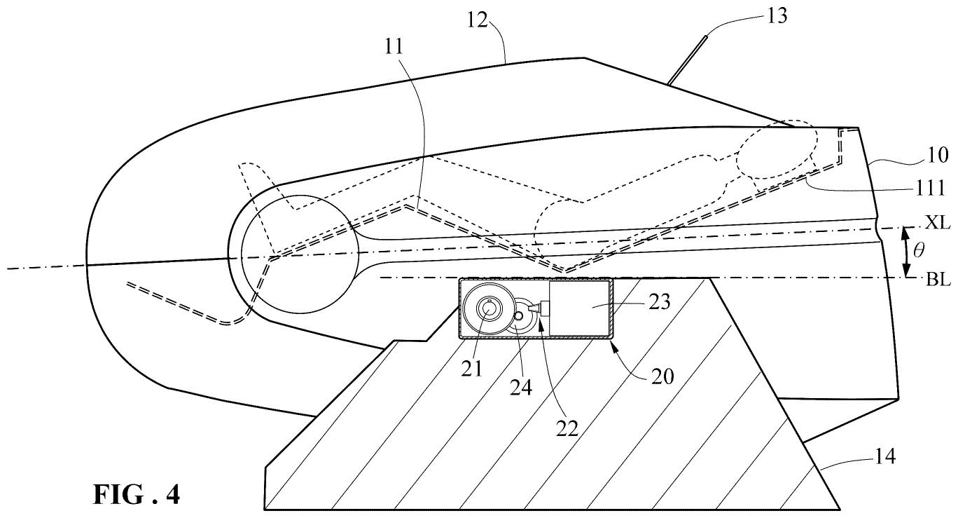

In FIGS. 3 and 4, the driving device 22 is a motor 23 including a reduction mechanism, and the gear set 24 outputs rotational power to control the rotation of the rotating shaft 21, thereby changing the inclination angle of the cabin body 10.

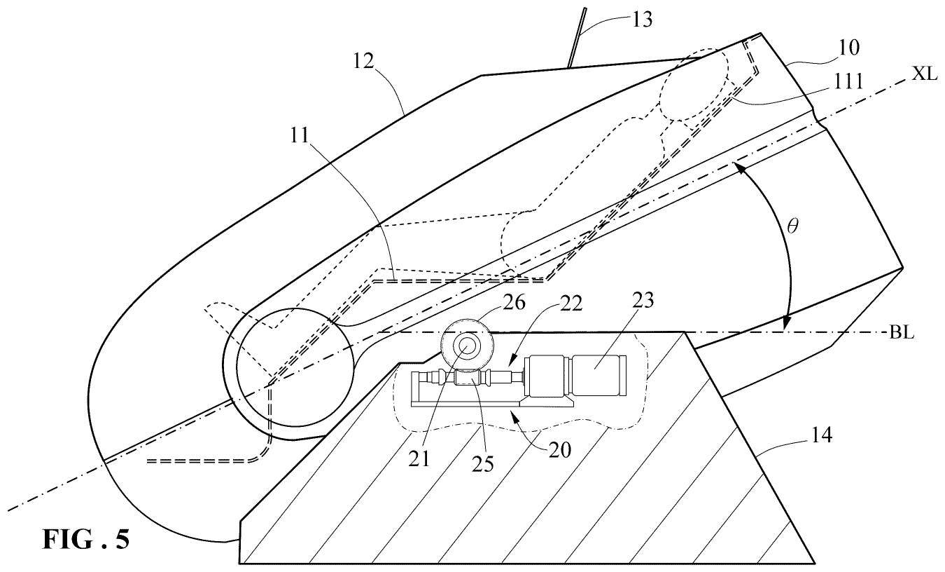

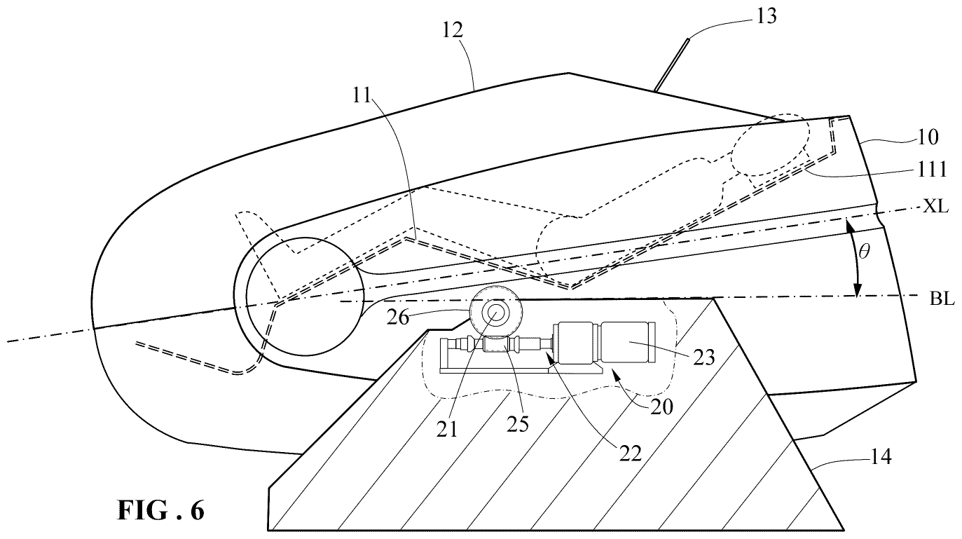

In FIGS. 5 and 6, the driving device 22 is a worm gear mechanism 6. The motor 23 including the reduction mechanism controls the rotation of the worm 25, and the rotating shaft 21 is fixed through the axis center of the worm gear 26. The worm 25 and the worm gear 26 output rotational power to control the rotation of the rotating shaft 21, thereby changing the inclination angle of the cabin body 10.

FIGS. 3 to 6 only disclose two types of driving devices 22, but are not limited thereto. Any device that can output slow rotation power to drive the rotating shaft 21 to rotate clockwise or counterclockwise at a predetermined angle around the axis thereof is within the scope of the present invention.

The controller 13 provides the inclination angle of the cabin body 10 for the user to pre-select, so that the parameter of controlling the adjusting mechanism 20 is obtained, and then the adjusting mechanism 20 is controlled to regulate the cabin body 10 to the inclination angle preselected by the user. For example, in FIGS. 3 and 5, the relative angle between the axis line XL and the baseline BL is about 45 degrees, and the user is in a high-angle semi-recumbent position. For example, in FIGS. 4 and 6, the relative angle between the axis line XL and the baseline BL is about 25 degrees, and the user is in a low-angle semi-recumbent position.

What is claimed is:

1. An angle-adjustable sauna cabin, comprising:
a cabin body supported by a base; a hatch cover connected with the cabin body that allows opening and closing; a controller arranged at a position that allows a user in the cabin body to be touched and operated; and an adjusting mechanism connected with the cabin body to adjust an inclination angle of the cabin body, wherein the controller is electrically connected with the adjusting mechanism, and the controller provides the inclination angle of the cabin body for the user to pre-select, so that a parameter of controlling the adjusting mechanism is obtained, and then the adjusting mechanism is controlled to regulate the cabin body to the inclination angle preselected.

2. The angle-adjustable sauna cabin, as recited in claim 1, wherein the adjusting mechanism comprises a rotating shaft and a driving device that drives the rotating shaft to rotate clockwise or counterclockwise at a predetermined angle around an axis thereof, wherein the rotating shaft is provided at a bottom of the cabin body, and the driving device is provided on the base, wherein the rotation of the rotating shaft links the cabin body to change the inclination angle.
